(19) United States
(12) Patent Application Publication
(10) Pub. No.: US 2024/0161435 A1
(43) Pub. Date: May 16, 2024

(54) ALIGNMENT OF LOCATION-DEPENDENT VISUALIZATION DATA IN AUGMENTED REALITY

(71) Applicant: FARO Technologies, Inc., Lake Mary, FL (US)

(72) Inventors: Angelo Wostal, Ahlen (DE); John Chan, Montreal (CA); Michael MÜLLER, Stuttgart (DE); Daniel Korgel, Bochum (DE); Daniel Pompe, Leonberg (DE)

(21) Appl. No.: 18/446,023

(22) Filed: Aug. 8, 2023

Related U.S. Application Data
(60) Provisional application No. 63/424,673, filed on Nov. 11, 2022.

(51) Int. Cl. G06T 19/20; G06T 19/00

(52) U.S. Cl. CPC G06T 19/20; G06T 19/006; G06T 2219/2004; G06T 2219/2016

(57) ABSTRACT

Examples described herein provide a method for point cloud alignment. The method includes receiving a first set of three-dimensional (3D) points of an environment. The method further includes capturing a second set of 3D points of the environment using a sensor of a processing system. The method further includes aligning the first set of 3D points of the environment with the second set of 3D points of the environment to create a point cloud of the environment. The method further includes generating, on a display of the processing system, a graphical representation of the point cloud of the environment. The graphical representation displays at least a portion of the first set of 3D points of the environment as an augmented reality element.

### CROSS-REFERENCE TO RELATED APPLICATIONS

This application claims the benefit of U.S. Provisional Patent Application Ser. No. 63/424,673, filed Nov. 11, 2022, and entitled “ALIGNMENT OF LOCATION-DEPENDENT VISUALIZATION DATA IN AUGMENTED REALITY,” the contents of which are incorporated by reference herein in their entirety.

### BACKGROUND

The subject matter disclosed herein relates to use of a three-dimensional (3D) laser scanner time-of-flight (TOF) coordinate measurement device. A 3D laser scanner of this type steers a beam of light to a non-cooperative target such as a diffusely scattering surface of an object. A distance meter in the device measures a distance to the object, and angular encoders measure the angles of rotation of two axles in the device. The measured distance and two angles enable a processor in the device to determine the 3D coordinates of the target.

A TOF laser scanner is a scanner in which the distance to a target point is determined based on the speed of light in air between the scanner and a target point. Laser scanners are typically used for scanning closed or open spaces such as interior areas of buildings, industrial installations and tunnels. They may also be used, for example, in industrial applications and accident reconstruction applications. A laser scanner optically scans and measures objects in a volume around the scanner through the acquisition of data points representing object surfaces within the volume. Such data points are obtained by transmitting a beam of light onto the objects and collecting the reflected or scattered light to determine the distance, two-angles (i.e., an azimuth and a zenith angle), and optionally a gray-scale value. This raw scan data is collected, stored and sent to a processor or processors to generate a 3D image representing the scanned area or object.

Generating an image requires at least three values for each data point. These three values may include the distance and two angles, or may be transformed values, such as the x, y, z coordinates. In an embodiment, an image is also based on a fourth gray-scale value, which is a value related to irradiance of scattered light returning to the scanner.

Most TOF scanners direct the beam of light within the measurement volume by steering the light with a beam steering mechanism. The beam steering mechanism includes a first motor that steers the beam of light about a first axis by a first angle that is measured by a first angular encoder (or another angle transducer). The beam steering mechanism also includes a second motor that steers the beam of light about a second axis by a second angle that is measured by a second angular encoder (or another angle transducer).

Many contemporary laser scanners include a camera mounted on the laser scanner for gathering camera digital images of the environment and for presenting the camera digital images to an operator of the laser scanner. By viewing the camera images, the operator of the scanner can determine the field of view of the measured volume and adjust settings on the laser scanner to measure over a larger or smaller region of space. In addition, the camera digital images may be transmitted to a processor to add color to the scanner image. To generate a color scanner image, at least three positional coordinates (such as x, y, z) and three color values (such as red, green, blue “RGB”) are collected for each data point.

One application where 3D scanners are used is to scan an environment.

Accordingly, while existing 3D scanners are suitable for their intended purposes, what is needed is a 3D scanner having certain features of embodiments of the present invention.

### BRIEF DESCRIPTION

In one exemplary embodiment, a method for point cloud alignment is provided. The method includes receiving a first set of three-dimensional (3D) points of an environment. The method further includes capturing a second set of 3D points of the environment using a sensor of a processing system. The method further includes aligning the first set of 3D points of the environment with the second set of 3D points of the environment to create a point cloud of the environment. The method further includes generating, on a display of the processing system, a graphical representation of the point cloud of the environment. The graphical representation displays at least a portion of the first set of 3D points of the environment as an augmented reality element.

In addition to one or more of the features described herein, or as an alternative, further embodiments of the method may include that the first set of 3D points were captured by a 3D coordinate measurement device.

In addition to one or more of the features described herein, or as an alternative, further embodiments of the method may include that the 3D coordinate measurement device is a laser scanner.

In addition to one or more of the features described herein, or as an alternative, further embodiments of the method may include that aligning the first set of 3D points of the environment with the second set of 3D points of the environment is performed using a 4-points congruent sets for robust surface registration (4PCS) alignment.

In addition to one or more of the features described herein, or as an alternative, further embodiments of the method may include that aligning the first set of 3D points of the environment with the second set of 3D points of the environment is performed using a coarse alignment followed by a fine alignment to refine results of the coarse alignment.

In addition to one or more of the features described herein, or as an alternative, further embodiments of the method may include that the coarse alignment is performed using a 4-points congruent sets for robust surface registration (4PCS) alignment, and wherein the fine alignment is performed using an iterative closest point (ICP) alignment.

In addition to one or more of the features described herein, or as an alternative, further embodiments of the method may include that aligning the first set of 3D points of the environment with the second set of 3D points of the environment determines a position and rotation estimate for adjusting the first set of 3D points of the environment to align with the second set of 3D points of the environment.

In addition to one or more of the features described herein, or as an alternative, further embodiments of the method may include that aligning the first set of 3D points of the environment with the second set of 3D points of the environment uses the position and rotation estimate to move location dependent data for the first set of 3D points of the environment to a correct place relative to the second set of 3D points of the environment.

In addition to one or more of the features described herein, or as an alternative, further embodiments of the method may include that the sensor is a camera and that the second set of 3D points are determined using photogrammetry.

In addition to one or more of the features described herein, or as an alternative, further embodiments of the method may include that the sensor is a light detection and ranging (LIDAR) sensor.

In addition to one or more of the features described herein, or as an alternative, further embodiments of the method may include that the processing system is a smartphone or a tablet computer.

In addition to one or more of the features described herein, or as an alternative, further embodiments of the method may include that the 3D coordinate measurement device is a laser scanner that includes: a scanner processing system including a scanner controller; a housing; and a 3D scanner disposed within the housing and operably coupled to the scanner processing system, the 3D scanner having a light source, a beam steering unit, a first angle measuring device, a second angle measuring device, and a light receiver, the beam steering unit cooperating with the light source and the light receiver to define a scan area, the light source and the light receiver configured to cooperate with the scanner processing system to determine a first distance to a first object point based at least in part on a transmitting of a light by the light source and a receiving of a reflected light by the light receiver, the 3D scanner configured to cooperate with the scanner processing system to determine 3D coordinates of the first object point based at least in part on the first distance, a first angle of rotation, and a second angle of rotation.

In another exemplary embodiment a system includes a three-dimensional (3D) coordinate measurement device to capture a first set of 3D points of an environment. The system further includes a processing system communicatively coupled to the 3D coordinate measurement device. The processing system includes a display, a memory including computer readable instructions, and a processing device for executing the computer readable instructions. The computer readable instructions control the processing device to perform operations. The operations include receiving the first set of 3D points of the environment from the 3D coordinate measurement device. The operations include capturing a second set of 3D points of the environment using a sensor of the processing system. The operations include aligning the first set of 3D points of the environment with the second set of 3D points of the environment to create a point cloud of the environment. The operations include generating, on the display, a graphical representation of the point cloud of the environment, where the graphical representation displays at least a portion of the first set of 3D points of the environment as an augmented reality element.

In addition to one or more of the features described herein, or as an alternative, further embodiments of the method may include that the first set of 3D points were captured by a 3D coordinate measurement device.

In addition to one or more of the features described herein, or as an alternative, further embodiments of the method may include that the 3D coordinate measurement device is a laser scanner.

In addition to one or more of the features described herein, or as an alternative, further embodiments of the method may include that aligning the first set of 3D points of the environment with the second set of 3D points of the environment is performed using a 4-points congruent sets for robust surface registration (4PCS) alignment.

In addition to one or more of the features described herein, or as an alternative, further embodiments of the method may include that aligning the first set of 3D points of the environment with the second set of 3D points of the environment is performed using a coarse alignment followed by a fine alignment to refine results of the coarse alignment.

In addition to one or more of the features described herein, or as an alternative, further embodiments of the method may include that the coarse alignment is performed using a 4-points congruent sets for robust surface registration (4PCS) alignment, and wherein the fine alignment is performed using an iterative closest point (ICP) alignment.

In addition to one or more of the features described herein, or as an alternative, further embodiments of the method may include that aligning the first set of 3D points of the environment with the second set of 3D points of the environment determines a position and rotation estimate for adjusting the first set of 3D points of the environment to align with the second set of 3D points of the environment.

In addition to one or more of the features described herein, or as an alternative, further embodiments of the method may include that aligning the first set of 3D points of the environment with the second set of 3D points of the environment uses the position and rotation estimate to move location dependent data for the first set of 3D points of the environment to a correct place relative to the second set of 3D points of the environment.

In addition to one or more of the features described herein, or as an alternative, further embodiments of the method may include that the sensor is a camera and wherein the second set of 3D points are determined using photogrammetry.

In addition to one or more of the features described herein, or as an alternative, further embodiments of the method may include that the sensor is a light detection and ranging (LIDAR) sensor.

In addition to one or more of the features described herein, or as an alternative, further embodiments of the method may include that the processing system is a smartphone or a tablet computer.

In addition to one or more of the features described herein, or as an alternative, further embodiments of the method may include that the 3D coordinate measurement device is a laser scanner that includes: a scanner processing system including a scanner controller; a housing; and a 3D scanner disposed within the housing and operably coupled to the scanner processing system, the 3D scanner having a light source, a beam steering unit, a first angle measuring device, a second angle measuring device, and a light receiver, the beam steering unit cooperating with the light source and the light receiver to define a scan area, the light source and the light receiver configured to cooperate with the scanner processing system to determine a first distance to a first object point based at least in part on a transmitting of a light by the light source and a receiving of a reflected light by the light receiver, the 3D scanner configured to cooperate with the scanner processing system to determine 3D coordinates of the first object point based at least in part on the first distance, a first angle of rotation, and a second angle of rotation.

The above features and advantages, and other features and advantages, of the disclosure are readily apparent from the following detailed description when taken in connection with the accompanying drawings.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of a laser scanner according to one or more embodiments described herein;

FIG. 2 is a side view of the laser scanner illustrating a method of measurement according to one or more embodiments described herein;

FIG. 3 is a schematic illustration of the optical, mechanical, and electrical components of the laser scanner according to one or more embodiments described herein;

FIG. 4 is a schematic illustration of the laser scanner of FIG. 1 according to one or more embodiments described herein;

FIG. 5 is a schematic illustration of a processing system for aligning and visualizing a point cloud according to one or more embodiments described herein;

FIG. 6 is a flow diagram of a method for aligning and visualizing a point cloud according to one or more embodiments described herein;

FIG. 7 is a flow diagram of a method for aligning and visualizing a point cloud according to one or more embodiments described herein;

FIGS. 8A-8D are interfaces to be displayed on a display of the processing system of FIG. 5 according to one or more embodiments described herein; and

FIG. 9 is a schematic illustration of a processing system for implementing the presently described techniques according to one or more embodiments described herein.

The detailed description explains embodiments of the disclosure, together with advantages and features, by way of example with reference to the drawings.

### DETAILED DESCRIPTION

Embodiments described herein provide for aligning and visualizing a point cloud. Particularly, one or more embodiments described herein relate to performing an alignment of location-dependent visualization data in augmented reality.

Three-dimensional (3D) coordinate measurement devices, such as laser scanners, can be used to capture 3D data about an environment. The 3D data can be presented on a device, such as a smartphone, tablet, heads-up display, etc., as a graphical representation. In some cases, the graphical representation of the point cloud can be overlaid on a video stream of the environment that the point cloud represents. In such cases, the point cloud may not properly align to the environment. It is desirable to align the graphical representation of the point cloud with the environment.

Conventional techniques for aligning the graphical representation of the point cloud with the environment are often insufficient. For example, it can be difficult to locate problematic areas in the physical world. Although augmented reality can aid in addressing this concern, the need for localizing the point cloud with the environment remains. Moreover, it can be difficult to combine data from multiple point clouds, especially on devices such as smartphones and/or tablet computers, for example, because these devices can have difficulty processing large volumes of data often associated with point clouds (e.g., millions or billions of data points).

To address these and other shortcomings of the prior art, one or more embodiments described herein provide for performing an alignment of location-dependent visualization data in augmented reality. For example, one or more embodiments provide for automatically overlaying location dependent visualization data on top of the reality (e.g., a video stream) in an augmented reality (AR) mode of a user device (e.g., a smartphone, a tablet computer, an AR heads up display, and/or the like, including combinations and/or multiples thereof). Computer functionality is improved using the alignment described herein (e.g., aligning the first set of 3D points of the environment with the second set of 3D points of the environment to create a point cloud of the environment). For example, the aligning can be performed when a suitable number of points are collected before having to collect additional points. This reduces the amount of data to be stored and processed, thus improving the functionality of computing devices.

One or more embodiments described herein utilize AR, which provides for enhancing the real physical world by delivering digital visual elements, sound, or other sensory stimuli (an “AR element”) via technology. For example, a user device (e.g., a smartphone, tablet computer, etc.) equipped with a camera and display can be used to capture an image of an environment. In some cases, this includes using the camera to capture a live, real-time representation of an environment (e.g., a video stream) and displaying that representation on the display. An AR element can be displayed on the display and can be associated with an object/feature of the environment. For example, an AR element with information about how to operate a particular piece of equipment can be associated with that piece of equipment and can be digitally displayed on the display of the user device as an AR element along with a video stream of the environment captured by the user device's camera. As another example, a point cloud of 3D data is represented as an AR element on a real-time video stream of the environment. It is useful to know the location of the user device relative to the environment in order to accurately depict AR elements.

In order to visualize location dependent data on top of the reality (e.g., a video stream captured by a camera of a processing system, such as a smartphone or tablet computer) in augmented reality, the location dependent data is aligned in the current camera view so that the virtual data is positioned at the real-life location that it belongs to. To achieve this alignment, one or more embodiments described herein finding correspondences between the visualization data and the augmented reality environment. Once aligned, the virtual data offers the user additional location dependent information like floor heights, annotations, etc.

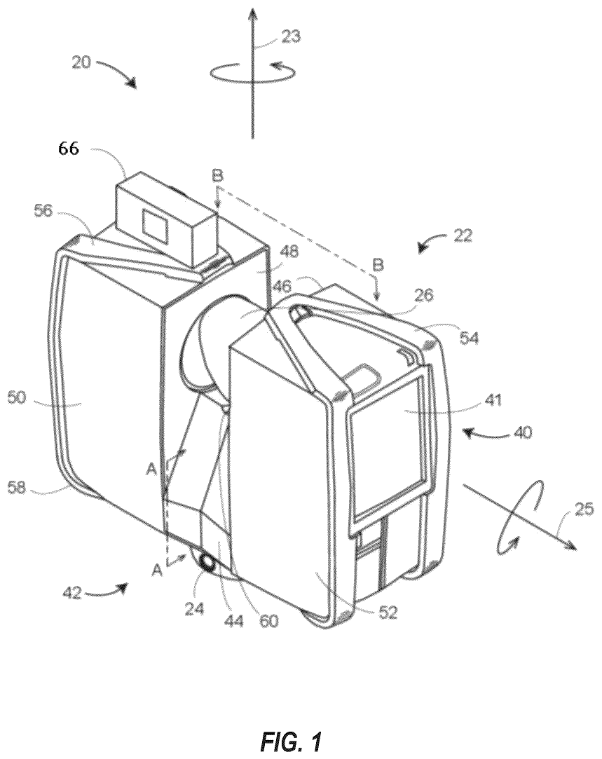

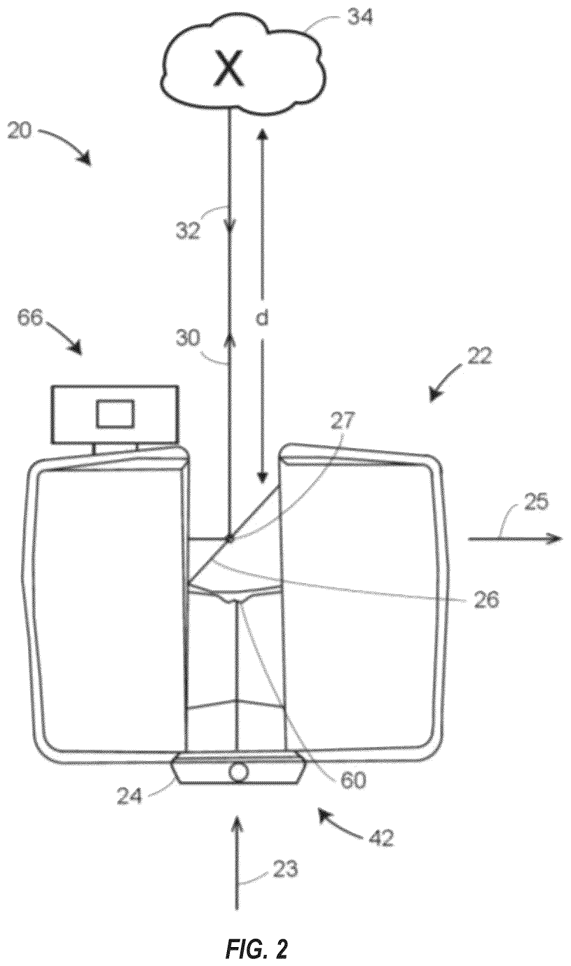

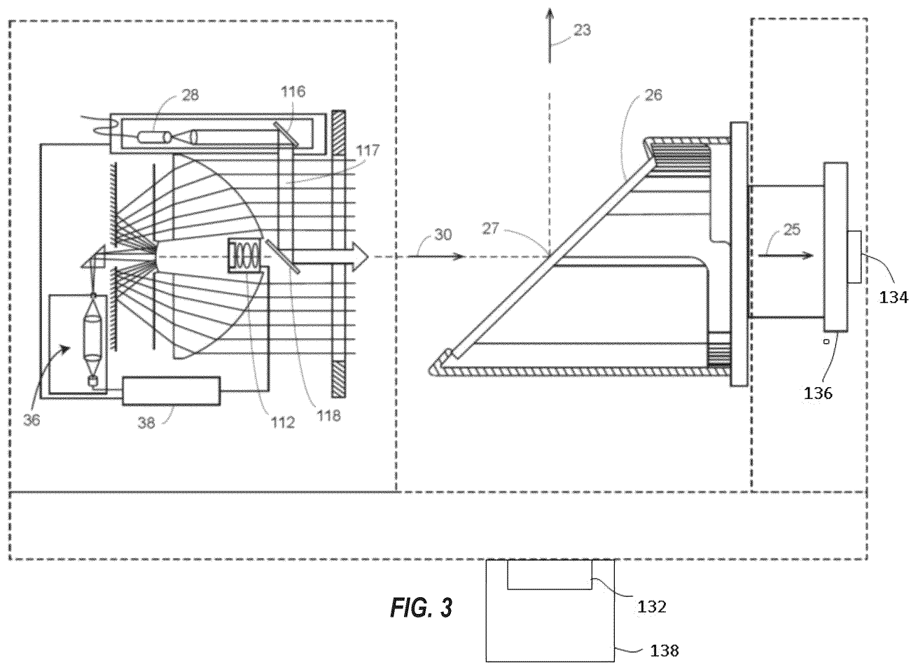

Referring now to FIGS. 1-3, a 3D coordinate measurement device, such as a laser scanner 20, is shown for optically scanning and measuring the environment surrounding the laser scanner 20 according to one or more embodiments described herein. The laser scanner 20 has a measuring head 22 and a base 24. The measuring head 22 is mounted on the base 24 such that the laser scanner 20 may be rotated about a vertical axis 23. In one embodiment, the measuring head 22 includes a gimbal point 27 that is a center of rotation about the vertical axis 23 and a horizontal axis 25. The measuring head 22 has a rotary mirror 26, which may be rotated about the horizontal axis 25. The rotation about the vertical axis may be about the center of the base 24. The terms vertical axis and horizontal axis refer to the scanner in its normal upright position. It is possible to operate a 3D coordinate measurement device on its side or upside down, and so to avoid confusion, the terms azimuth axis and zenith axis may be substituted for the terms vertical axis and horizontal axis, respectively. The term pan axis or standing axis may also be used as an alternative to vertical axis.

The measuring head 22 is further provided with an electromagnetic radiation emitter, such as light emitter 28, for example, that emits an emitted light beam 30. In one embodiment, the emitted light beam 30 is a coherent light beam such as a laser beam. The laser beam may have a wavelength range of approximately 300 to 1600 nanometers, for example 790 nanometers, 905 nanometers, 1550 nm, or less than 400 nanometers. It should be appreciated that other electromagnetic radiation beams having greater or smaller wavelengths may also be used. The emitted light beam 30 is amplitude or intensity modulated, for example, with a sinusoidal waveform or with a rectangular waveform. The emitted light beam 30 is emitted by the light emitter 28 onto a beam steering unit, such as mirror 26, where it is deflected to the environment. A reflected light beam 32 is reflected from the environment by an object 34. The reflected or scattered light is intercepted by the rotary mirror 26 and directed into a light receiver 36. The directions of the emitted light beam 30 and the reflected light beam 32 result from the angular positions of the rotary mirror 26 and the measuring head 22 about the axes 25 and 23, respectively. These angular positions in turn depend on the corresponding rotary drives or motors.

Coupled to the light emitter 28 and the light receiver 36 is a controller 38. The controller 38 determines, for a multitude of measuring points X, a corresponding number of distances d between the laser scanner 20 and the points X on object 34. The distance to a particular point X is determined based at least in part on the speed of light in air through which electromagnetic radiation propagates from the device to the object point X. In one embodiment the phase shift of modulation in light emitted by the laser scanner 20 and the point X is determined and evaluated to obtain a measured distance d.

The speed of light in air depends on the properties of the air such as the air temperature, barometric pressure, relative humidity, and concentration of carbon dioxide. Such air properties influence the index of refraction n of the air. The speed of light in air is equal to the speed of light in vacuum c divided by the index of refraction. In other words, cₐᵢᵣ=c/n. A laser scanner of the type discussed herein is based on the time-of-flight (TOF) of the light in the air (the round-trip time for the light to travel from the device to the object and back to the device). Examples of TOF scanners include scanners that measure round trip time using the time interval between emitted and returning pulses (pulsed TOF scanners), scanners that modulate light sinusoidally and measure phase shift of the returning light (phase-based scanners), as well as many other types. A method of measuring distance based on the time-of-flight of light depends on the speed of light in air and is therefore easily distinguished from methods of measuring distance based on triangulation. Triangulation-based methods involve projecting light from a light source along a particular direction and then intercepting the light on a camera pixel along a particular direction. By knowing the distance between the camera and the projector and by matching a projected angle with a received angle, the method of triangulation enables the distance to the object to be determined based on one known length and two known angles of a triangle. The method of triangulation, therefore, does not directly depend on the speed of light in air.

In one mode of operation, the scanning of the volume around the laser scanner 20 takes place by rotating the rotary mirror 26 relatively quickly about axis 25 while rotating the measuring head 22 relatively slowly about axis 23, thereby moving the assembly in a spiral pattern. In an exemplary embodiment, the rotary minor rotates at a maximum speed of 5820 revolutions per minute. For such a scan, the gimbal point 27 defines the origin of the local stationary reference system. The base 24 rests in this local stationary reference system.

In addition to measuring a distance d from the gimbal point 27 to an object point X, the laser scanner 20 may also collect gray-scale information related to the received optical power (equivalent to the term “brightness.”) The gray-scale value may be determined at least in part, for example, by integration of the bandpass-filtered and amplified signal in the light receiver 36 over a measuring period attributed to the object point X.

The measuring head 22 may include a display device 40 integrated into the laser scanner 20. The display device 40 may include a graphical touch screen 41, as shown in FIG. 1, which allows the operator to set the parameters or initiate the operation of the laser scanner 20. For example, the screen 41 may have a user interface that allows the operator to provide measurement instructions to the device, and the screen may also display measurement results.

The laser scanner 20 includes a carrying structure 42 that provides a frame for the measuring head 22 and a platform for attaching the components of the laser scanner 20. In one embodiment, the carrying structure 42 is made from a metal such as aluminum. The carrying structure 42 includes a traverse member 44 having a pair of walls 46, 48 on opposing ends. The walls 46, 48 are parallel to each other and extend in a direction opposite the base 24. Shells 50, 52 are coupled to the walls 46, 48 and cover the components of the laser scanner 20. In the exemplary embodiment, the shells 50, 52 are made from a plastic material, such as polycarbonate or polyethylene for example. The shells 50, 52 cooperate with the walls 46, 48 to form a housing for the laser scanner 20.

On an end of the shells 50, 52 opposite the walls 46, 48 a pair of yokes 54, 56 are arranged to partially cover the respective shells 50, 52. In the exemplary embodiment, the yokes 54, 56 are made from a suitably durable material, such as aluminum for example, that assists in protecting the shells 50, 52 during transport and operation. The yokes 54, 56 each includes a first arm portion 58 that is coupled, such as with a fastener for example, to the traverse 44 adjacent the base 24. The arm portion 58 for each yoke 54, 56 extends from the traverse 44 obliquely to an outer corner of the respective shell 50, 52. From the outer corner of the shell, the yokes 54, 56 extend along the side edge of the shell to an opposite outer corner of the shell. Each yoke 54, 56 further includes a second arm portion that extends obliquely to the walls 46, 48. It should be appreciated that the yokes 54, 56 may be coupled to the traverse 42, the walls 46, 48 and the shells 50, 54 at multiple locations.

The pair of yokes 54, 56 cooperate to circumscribe a convex space within which the two shells 50, 52 are arranged. In the exemplary embodiment, the yokes 54, 56 cooperate to cover all of the outer edges of the shells 50, 54, while the top and bottom arm portions project over at least a portion of the top and bottom edges of the shells 50, 52. This provides advantages in protecting the shells 50, 52 and the measuring head 22 from damage during transportation and operation. In other embodiments, the yokes 54, 56 may include additional features, such as handles to facilitate the carrying of the laser scanner 20 or attachment points for accessories for example.

On top of the traverse 44, a prism 60 is provided. The prism extends parallel to the walls 46, 48. In the exemplary embodiment, the prism 60 is integrally formed as part of the carrying structure 42. In other embodiments, the prism 60 is a separate component that is coupled to the traverse 44. When the mirror 26 rotates, during each rotation the mirror 26 directs the emitted light beam 30 onto the traverse 44 and the prism 60. Due to non-linearities in the electronic components, for example in the light receiver 36, the measured distances d may depend on signal strength, which may be measured in optical power entering the scanner or optical power entering optical detectors within the light receiver 36, for example. In an embodiment, a distance correction is stored in the scanner as a function (possibly a nonlinear function) of distance to a measured point and optical power (generally unscaled quantity of light power sometimes referred to as “brightness”) returned from the measured point and sent to an optical detector in the light receiver 36. Since the prism 60 is at a known distance from the gimbal point 27, the measured optical power level of light reflected by the prism 60 may be used to correct distance measurements for other measured points, thereby allowing for compensation to correct for the effects of environmental variables such as temperature. In the exemplary embodiment, the resulting correction of distance is performed by the controller 38.

In an embodiment, the base 24 is coupled to a swivel assembly (not shown) such as that described in commonly owned U.S. Pat. No. 8,705,012 ('012), which is incorporated by reference herein. The swivel assembly is housed within the carrying structure 42 and includes a motor 138 that is configured to rotate the measuring head 22 about the axis 23. In an embodiment, the angular/rotational position of the measuring head 22 about the axis 23 is measured by angular encoder 134.

An auxiliary image acquisition device 66 may be a device that captures and measures a parameter associated with the scanned area or the scanned object and provides a signal representing the measured quantities over an image acquisition area. The auxiliary image acquisition device 66 may be, but is not limited to, a pyrometer, a thermal imager, an ionizing radiation detector, or a millimeter-wave detector. In an embodiment, the auxiliary image acquisition device 66 is a color camera.

In an embodiment, a central color camera (first image acquisition device) 112 is located internally to the scanner and may have the same optical axis as the 3D scanner device. In this embodiment, the first image acquisition device 112 is integrated into the measuring head 22 and arranged to acquire images along the same optical pathway as emitted light beam 30 and reflected light beam 32. In this embodiment, the light from the light emitter 28 reflects off a fixed mirror 116 and travels to dichroic beam-splitter 118 that reflects the light 117 from the light emitter 28 onto the rotary mirror 26. In an embodiment, the mirror 26 is rotated by a motor 136 and the angular/rotational position of the mirror is measured by angular encoder 134. The dichroic beam-splitter 118 allows light to pass through at wavelengths different than the wavelength of light 117. For example, the light emitter 28 may be a near infrared laser light (for example, light at wavelengths of 780 nm or 1250 nm), with the dichroic beam-splitter 118 configured to reflect the infrared laser light while allowing visible light (e.g., wavelengths of 400 to 700 nm) to transmit through. In other embodiments, the determination of whether the light passes through the beam-splitter 118 or is reflected depends on the polarization of the light. The digital camera 112 obtains 2D images of the scanned area to capture color data to add to the scanned image. In the case of a built-in color camera having an optical axis coincident with that of the 3D scanning device, the direction of the camera view may be easily obtained by simply adjusting the steering mechanisms of the scanner—for example, by adjusting the azimuth angle about the axis 23 and by steering the mirror 26 about the axis 25.

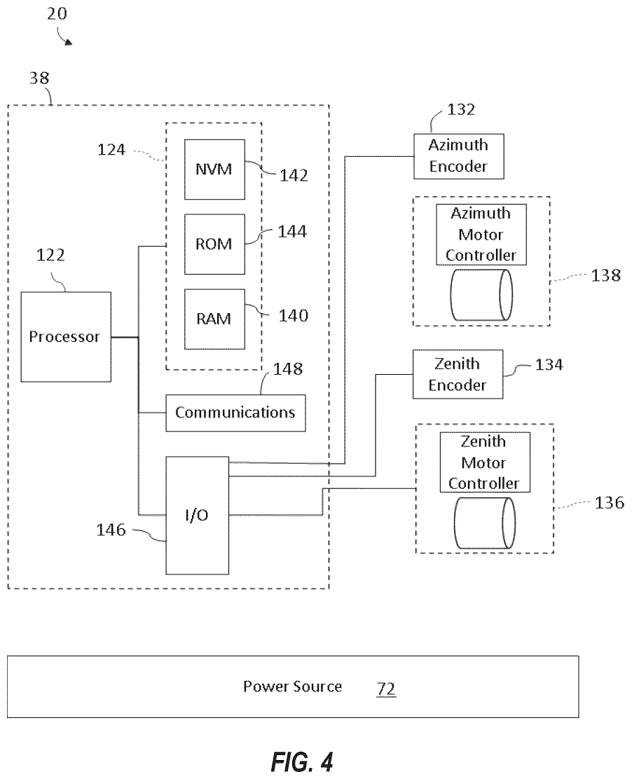

Referring now to FIG. 4 with continuing reference to FIGS. 1-3, elements are shown of the laser scanner 20. Controller 38 is a suitable electronic device capable of accepting data and instructions, executing the instructions to process the data, and presenting the results. The controller 38 includes one or more processing elements 122. The processors may be microprocessors, field programmable gate arrays (FPGAs), digital signal processors (DSPs), and generally any device capable of performing computing functions. The one or more processors 122 have access to memory 124 for storing information.

Controller 38 is capable of converting the analog voltage or current level provided by light receiver 36 into a digital signal to determine a distance from the laser scanner 20 to an object in the environment. Controller 38 uses the digital signals that act as input to various processes for controlling the laser scanner 20. The digital signals represent one or more laser scanner 20 data including but not limited to distance to an object, images of the environment, images acquired by panoramic camera 126, angular/rotational measurements by a first or azimuth encoder 132, and angular/rotational measurements by a second axis or zenith encoder 134.

In general, controller 38 accepts data from encoders 132, 134, light receiver 36, light source 28, and panoramic camera 126 and is given certain instructions for the purpose of generating a 3D point cloud of a scanned environment. Controller 38 provides operating signals to the light source 28, light receiver 36, panoramic camera 126, zenith motor 136 and azimuth motor 138. The controller 38 compares the operational parameters to predetermined variances and if the predetermined variance is exceeded, generates a signal that alerts an operator to a condition. The data received by the controller 38 may be displayed on a user interface 40 coupled to controller 38. The user interface 40 may be one or more LEDs (light-emitting diodes) 82, an LCD (liquid-crystal diode) display, a CRT (cathode ray tube) display, a touch-screen display or the like. A keypad may also be coupled to the user interface for providing data input to controller 38. In one embodiment, the user interface is arranged or executed on a mobile computing device that is coupled for communication, such as via a wired or wireless communications medium (e.g. Ethernet, serial, USB, Bluetooth™ or WiFi) for example, to the laser scanner 20.

The controller 38 may also be coupled to external computer networks such as a local area network (LAN) and the Internet. A LAN interconnects one or more remote computers, which are configured to communicate with controller 38 using a well-known computer communications protocol such as TCP/IP (Transmission Control Protocol/Internee) Protocol), RS-232, ModBus, and the like. Additional systems 20 may also be connected to LAN with the controllers 38 in each of these systems 20 being configured to send and receive data to and from remote computers and other systems 20. The LAN may be connected to the Internet. This connection allows controller 38 to communicate with one or more remote computers connected to the Internet.

The processors 122 are coupled to memory 124. The memory 124 may include random access memory (RAM) device 140, a non-volatile memory (NVM) device 142, and a read-only memory (ROM) device 144. In addition, the processors 122 may be connected to one or more input/output (I/O) controllers 146 and a communications circuit 148. In an embodiment, the communications circuit 92 provides an interface that allows wireless or wired communication with one or more external devices or networks, such as the LAN discussed above.

Controller 38 includes operation control methods embodied in application code (e.g., program instructions executable by a processor to cause the processor to perform operations). These methods are embodied in computer instructions written to be executed by processors 122, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, C #, Objective-C, Visual C++, Java, ALGOL (algorithmic language), BASIC (beginners all-purpose symbolic instruction code), visual BASIC, ActiveX, HTML (HyperText Markup Language), Python, Ruby and any combination or derivative of at least one of the foregoing.

It should be appreciated that while embodiments herein describe the 3D coordinate measurement device as being a laser scanner, this is for example purposes and the claims should not be so limited. In other embodiments, the 3D coordinate measurement device may be another type of system that measures a plurality of points on surfaces (i.e., generates a point cloud), such as but not limited to a triangulation scanner, a structured light scanner, or a photogrammetry device for example.

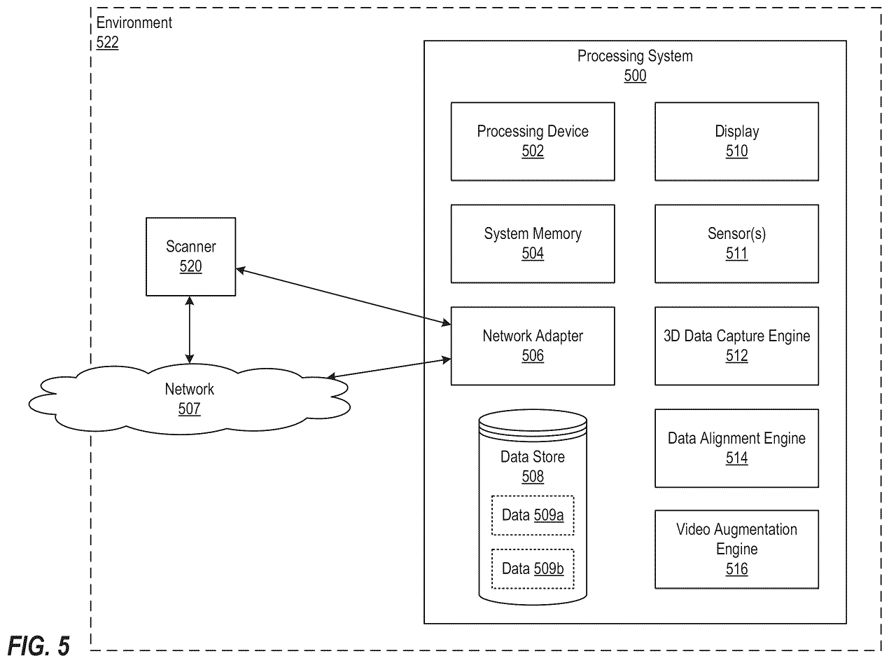

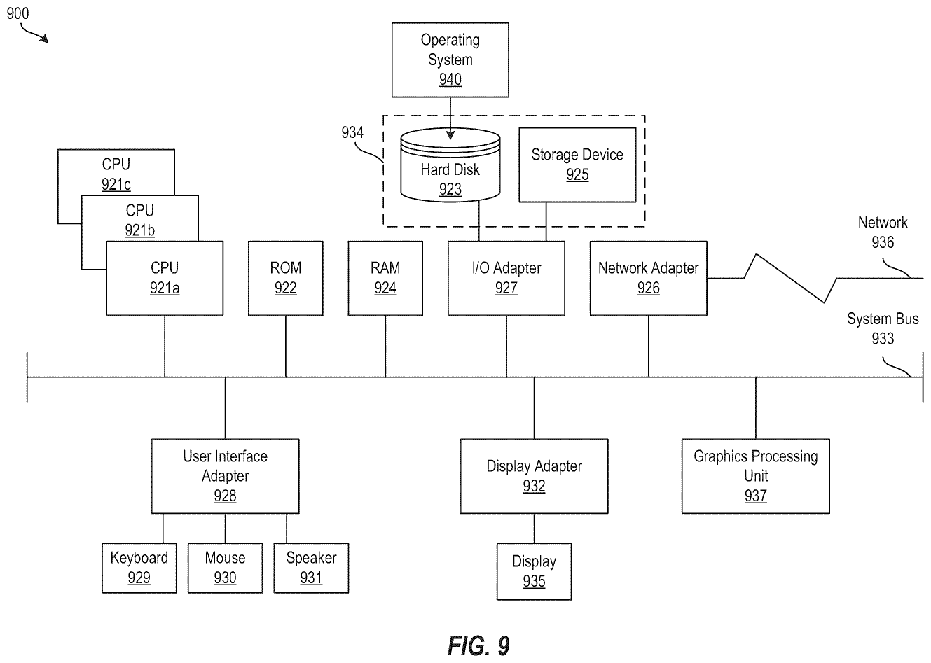

FIG. 5 is a schematic illustration of a processing system 500 for aligning and visualizing a point cloud according to one or more embodiments described herein. The processing system 500 can be any suitable computing device, such as a laptop computer, a desktop computer, a smartphone, a tablet computer, and/or the like, including combinations and/or multiples thereof. FIG. 9 depicts a processing system 900, which is an example of the processing system 500. As shown in FIG. 5, the processing system 500 includes a processing device 502 (e.g., one or more of the processing devices 921 of FIG. 9), a system memory 504 (e.g., the RAM 924 and/or the ROM 922 of FIG. 9), a network adapter 506 (e.g., the network adapter 926 of FIG. 9), a data store 508, a display 510, sensor(s) 511, a 3D data capture engine 512, a data alignment engine 514, and a video augmentation engine 516.

The various components, modules, engines, etc. described regarding FIG. 5 (e.g., the 3D data capture engine 512, the data alignment engine 514, and the video augmentation engine 516) can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming. The programming can be processor executable instructions stored on a tangible memory, and the hardware can include the processing device 502 for executing those instructions. Thus, the system memory 504 can store program instructions that when executed by the processing device 502 implement the engines described herein. Other engines can also be utilized to include other features and functionality described in other examples herein.

The network adapter 506 enables the processing system 500 to transmit data to and/or receive data from other sources, such as a scanner 520. For example, the processing system 500 receives data (e.g., a data set that includes a plurality of three-dimensional coordinates of an environment 522) from the scanner 520 directly and/or via a network 507. The data from the scanner 520 can be stored in the data store 508 of the processing system 500 as data 509a, which can be used to display a point cloud (also referred to as a “first point cloud”) on the display 510. According to one or more embodiments described herein, the 3D data capture engine 512 can use the sensor(s) 511 to capture additional 3D data of the environment 522 as data 509b, which may also be presented on the display 510. According to one or more embodiments described herein, the processing system 500 can generate an augmented reality representation of the data 509a and/or the data 509b as a point cloud (also referred to as a “second point cloud”), which can be displayed on the display 510.

The sensor(s) 511 can include one or more sensors for capturing data/information about the environment 522. The sensor(s) 511 can include one or more of the following: a camera, a panoramic camera, a 360-degree camera, a light detection and ranging (LIDAR) sensor, and/or the like, including combinations and/or multiples thereof.

The network 507 represents any one or a combination of different types of suitable communications networks such as, for example, cable networks, public networks (e.g., the Internet), private networks, wireless networks, cellular networks, or any other suitable private and/or public networks. Further, the network 507 can have any suitable communication range associated therewith and may include, for example, global networks (e.g., the Internet), metropolitan area networks (MANs), wide area networks (WANs), local area networks (LANs), or personal area networks (PANs). In addition, the network 507 can include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

The scanner 520 (e.g., a laser scanner) can be arranged on, in, and/or around the environment 522 to scan the environment 522. It should be appreciated that while embodiments herein refer to a 3D coordinate measurement device as a laser scanner (e.g., the scanner 520), this is for example purposes and the claims should not be so limited. In other embodiments, other types of optical measurement devices may be used, such as but not limited to triangulation scanners and structured light scanners for example.

According to one or more embodiments described herein, the scanner 520 can include a scanner processing system including a scanner controller, a housing, and a three-dimensional (3D) scanner. The 3D scanner can be disposed within the housing and operably coupled to the scanner processing system. The 3D scanner includes a light source, a beam steering unit, a first angle measuring device, a second angle measuring device, and a light receiver. The beam steering unit cooperates with the light source and the light receiver to define a scan area. The light source and the light receiver are configured to cooperate with the scanner processing system to determine a first distance to a first object point based at least in part on a transmitting of a light by the light source and a receiving of a reflected light by the light receiver. The 3D scanner is further configured to cooperate with the scanner processing system to determine 3D coordinates of the first object point based at least in part on the first distance, a first angle of rotation, and a second angle of rotation.

The scanner 520 performs at least one scan to generate a data set that includes a plurality of three-dimensional coordinates of the environment 522. The data set can be transmitted, directly or indirectly (such as via a network) to a processing system, such as the processing system 500, which can store the data set as the data 509a in the data store 508. It should be appreciated that other numbers of scanners (e.g., two scanner, three scanners, four scanners, six scanners, eight scanners, etc.) can be used. According to one or more embodiments described herein, one or more scanners can be used to take multiple scans. For example, the scanner 520 can capture first scan data at a first location and then be moved to a second location, where the scanner 520 captures second scan data.

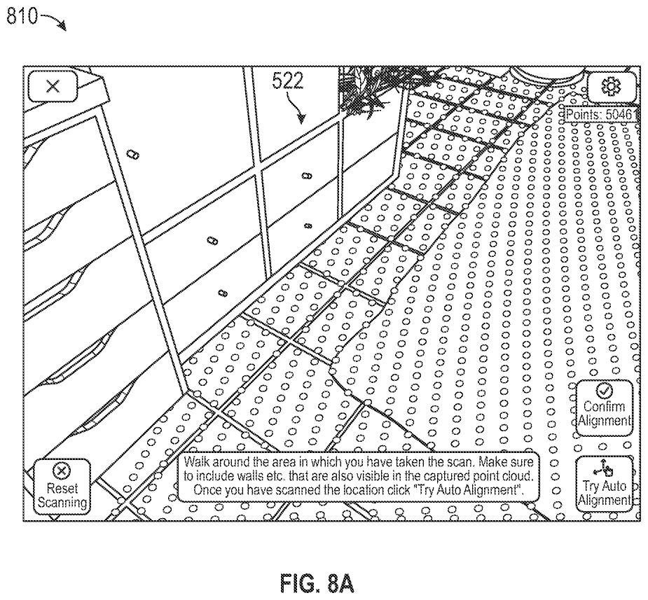

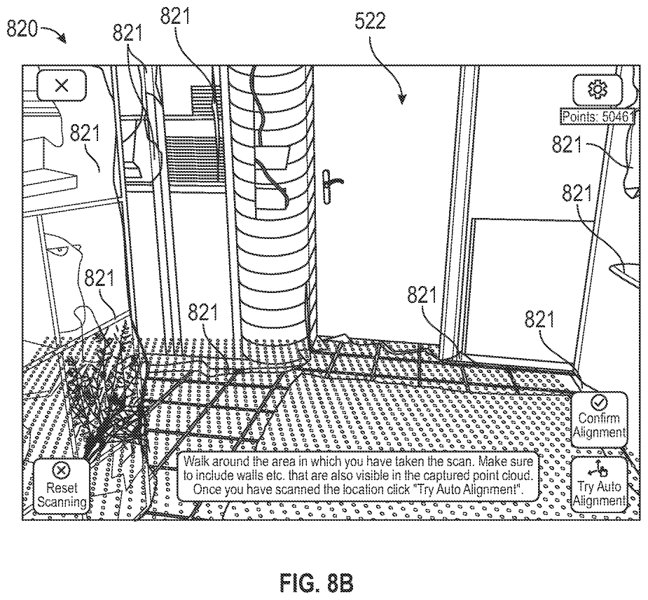

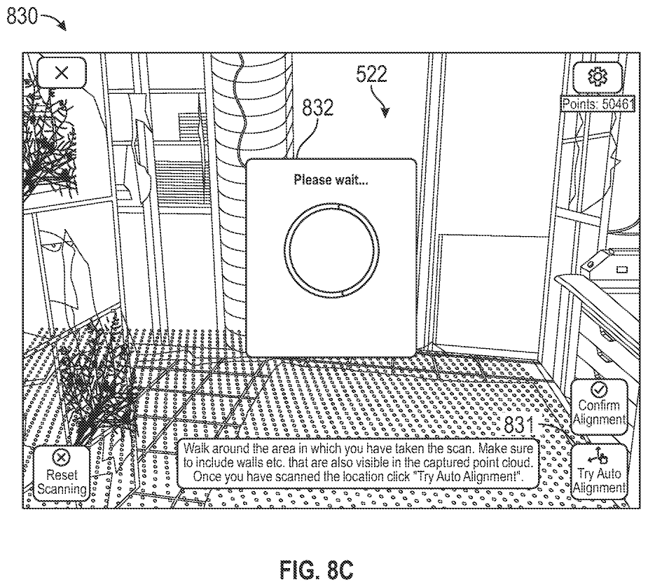

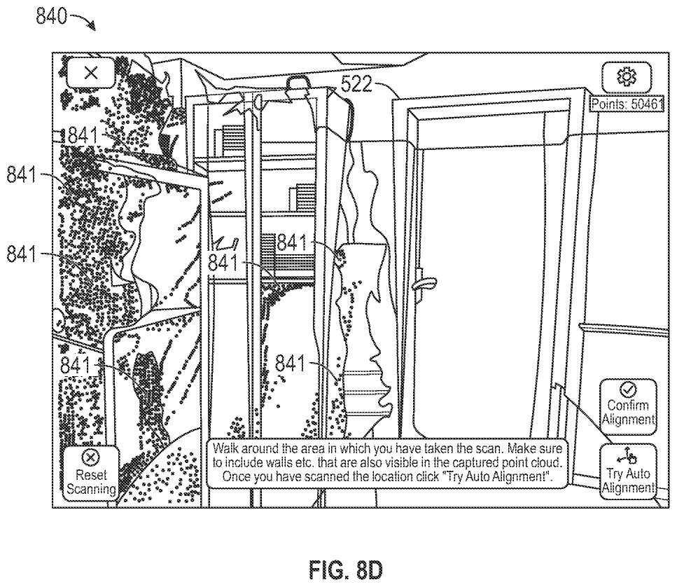

Using the data (e.g., the data 509a) received from the scanner 520 and the data (e.g., the data 509a) captured by the sensor(s) 511, the processing system 500 can preform alignment and visualization of a point cloud using one or more of the data alignment engine 514 and/or the video augmentation engine 516. For example, the data alignment engine 514 uses points in the data 509a and corresponding points in the data 509b to align the data 509a and the data 509b. The video augmentation engine 516 uses the data 509a and the data 590b to generate an augmented reality representation of the data 509a, 509b as a point cloud, which can be overlaid onto a video stream of the environment 522 captured, for example, by a camera (e.g., one of the sensor(s) 511). AR representations are further described herein, such as with reference to FIGS. 8A-8D. The features and functionality of the 3D data capture engine 512, the data alignment engine 514, and the video augmentation engine 516 are now described in more detail with reference to the following figures.

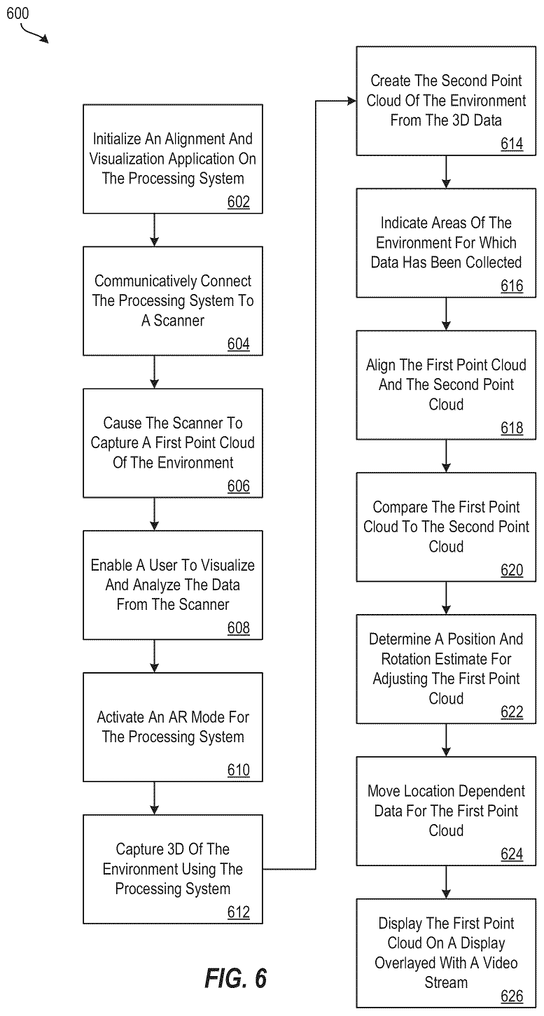

Turning now to FIG. 6, a flow diagram of a method 600 for aligning and visualizing a point cloud is provided according to one or more embodiments described herein. The method 600 can be performed by any suitable system or device, such as the processing system 500 of FIG. 5 and/or the processing system 900 of FIG. 9. FIG. 6 is now described in more detail with reference to FIGS. 5 and 8A-8D but is not so limited.

At block 602, a user initializes an alignment and visualization application on the processing system 500 (e.g., a smartphone or tablet computer). At block 604, the processing system 500 communicatively connects to the scanner 520, directly or indirectly (e.g., via the network 507). This enables the processing system 500 and the scanner 520 to exchange data, such as commands, 3D data, and/or the like, including combinations and/or multiples thereof. For example, at block 606, the processing system 500 can transmit a command to the scanner 520 to cause the scanner 520 to capture data (e.g., the data 509a) about the environment 522, also referred to as “scanning” the environment 522.

Once the processing system 500 receives the data 509a from the scanner 520, the processing system 500 enables a user to visualize and analyze the data 509a at block 608. This can include presenting the data 509a on the display 510 of the processing system 500. In one or more embodiments, the data 509a can be overlaid onto a video stream captured by the camera (e.g., one of the sensor(s) 511) as an AR element. According to an embodiment, the user can perform certain analyses on the data 509a (which may take the form of a point cloud), such as to change the appearance of the point cloud, perform measurements using the point cloud, provide additional data to the point cloud, and/or the like, including combinations and/or multiples thereof. For example, the user can create a colorized heatmap to show floor height differences in the point cloud, such as for a floor flatness and levelness analysis.

While the user is viewing the video stream of the environment 522, the user can capture and view location dependent data on top of the video stream. For example, FIG. 8A depicts an interface displayed on the display 510 that shows the video stream of the environment 522. To capture and view the data, the user may activate an AR mode for the processing system 500, which enables the processing system 500, using the video augmentation engine 516, to generate one or more AR elements using the data 509a at block 610. As an example, an AR element can indicate areas where data is collected by the sensors 511, as shown in FIG. 8B.

At block 612, one or more of the sensors 511 (e.g., a LIDAR sensor, a camera, and/or the like, including combinations and/or multiples thereof) captures 3D data about the environment and stores the data in the data store 508 as data 509b, which may be in the form of a point cloud (e.g., “second point cloud”). For example, the user walks around or otherwise traverses the environment 522 uses the processing system 500 to capture the data 509b. At block 614, while the data 509b is being captured, a point cloud (e.g., the “second point cloud) of the environment 522 is created using the video augmentation engine 516, such as using the data from a LIDAR sensor (e.g., the sensor(s) 511).

According to an embodiment, the data 509b generated from images captured using a camera (or multiple cameras) where a photogrammetry technique is applied to the captured images to generate the data 509b. Photogrammetry is a technique for measuring objects using images, such as photographic images acquired by a digital camera for example. Photogrammetry can make 3D measurements from 2D images or photographs. When two or more images are acquired at different positions that have an overlapping field of view, common points or features may be identified on each image. By projecting a ray from the camera location to the feature/point on the object, the 3D coordinate of the feature/point may be determined using trigonometry or triangulation. In some examples, photogrammetry may be based on markers/targets (e.g., lights or reflective stickers) or based on natural features. To perform photogrammetry, for example, images are captured, such as with a camera having a sensor, such as a photosensitive array for example. By acquiring multiple images of an object, or a portion of the object, from different positions or orientations, 3D coordinates of points on the object may be determined based on common features or points and information on the position and orientation of the camera when each image was acquired. In order to obtain the desired information for determining 3D coordinates, the features are identified in two or more images. Since the images are acquired from different positions or orientations, the common features are located in overlapping areas of the field of view of the images. It should be appreciated that photogrammetry techniques are described in commonly-owned U.S. Pat. No. 10,597,753, the contents of which are incorporated by reference herein. With photogrammetry, two or more images are captured and used to determine 3D coordinates of features (e.g., 3D data such as the data 509b).

At block 616, areas of the environment 522 for which data has already been collected (e.g., areas through with the user has already walked) are indicated, such as using color or other indicia. For example, FIG. 8B depicts an interface 820 displayed on the display 510. The interface 820 shows regions 821 that indicate areas of the environment 522 where data has already been collected. As an example, points of the second point cloud corresponding to areas of the environment 522 through with the user has already walked can be colored blue or another suitable color.

At block 618, the first point cloud (e.g., captured by the scanner 520) and the second point cloud (e.g., captured by the sensor(s) 511 of the processing system 500) are aligned using the data alignment engine 514. The alignment can be automatic (e.g., when a certain number of points of data are collected) and/or manual (e.g., the user can initiate the alignment, such as by selecting a “try auto alignment” button or other indicia on an interface of the processing system 500). For example, as shown in an interface 830 of FIG. 8C, the auto alignment can be performed by selecting the “try auto alignment” button 831, and a status window 832 can show the status of the alignment. According to an embodiment, the processing system 500 can determine whether a sufficient number of points have been collected for the second point cloud relative to the first point cloud. For example, if the first point cloud includes 500 million points, a threshold of 10% could be set for the second point cloud, and when those 10% (e.g., 50 million) of points have been collected, the alignment can be performed automatically. This improves processing system 500 performance by reducing the number of points of the second point cloud that are collected, processed, and stored.

Alignment can be performed by any suitable alignment technique as will be appreciated by those having ordinary skill in the art. For example, the first point cloud and the second point cloud can be aligned using 4-points congruent sets for robust surface registration (4PCS) alignment. 4PCS alignment extracts coplanar 4-points sets from 3D data (e.g., a point cloud) that are approximately congruent, under rigid transformation, to a given set of coplanar 4-points. 4PCS alignment is described in “4-POINTS CONGRUENT SETS FOR ROBUST SURFACE REGISTRATION” by Dror Aiger et al., which is incorporated by reference herein in its entirety. Other types of alignment algorithms can be applied additionally or alternatively. In some cases, the alignment can be a multi-stage alignment where first a coarse alignment is performed and then a fine alignment is performed to refine the coarse alignment. In such cases, the coarse alignment can be performed by the 4PCS alignment technique, and the fine alignment can be performed by another suitable alignment technique, one example of which is iterative closest point (ICP) alignment. ICP alignment minimizes a difference between two clouds of points. To do this, ICP alignment uses one point cloud as a reference (or “target”), which is kept fixed, and the other source point cloud is transformed to match the reference. ICP alignment iteratively revises the transformation to minimize error (e.g., distance between points of the point clouds).

At block 620, the data alignment engine 514 compares the first point cloud and the second point cloud. Because these two point clouds were captured in the same environment (e.g., the environment 522), the alignment identifies correspondences in the structure of the two point clouds. At block 622, the data alignment engine 514 can determine a position and rotation estimate for adjusting the first point cloud (e.g., a first set of 3D points captured by the scanner 520) to align with the second point cloud (e.g., a second set of 3D points captured by the processing system 500). At block 624, the data alignment engine 514 uses the position and rotation estimate from block 620 to move location dependent data for the first point cloud (e.g., a colorized heatmap used for a floor flatness and levelness analysis) to a correct place relative to the second point cloud. At block 626, the video augmentation engine 516 displays the first point cloud on the display 510 overlayed with a video stream of the environment 522, for example.

Additional processes also may be included, and it should be understood that the process depicted in FIG. 6 represents an illustration, and that other processes may be added or existing processes may be removed, modified, or rearranged without departing from the scope of the present disclosure.

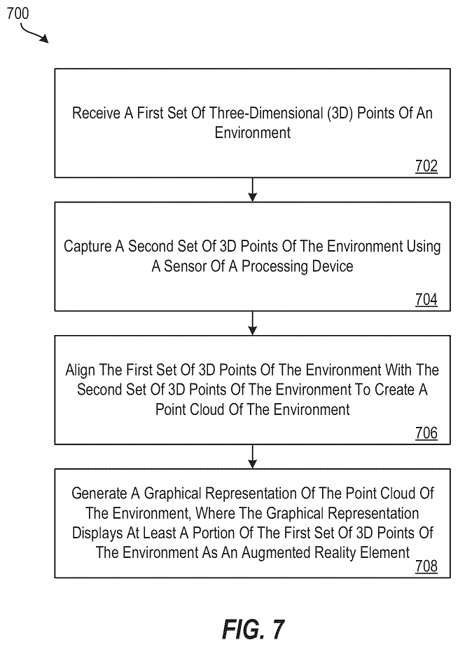

Turning now to FIG. 7, a flow diagram of a method 700 for aligning and visualizing a point cloud is provided according to one or more embodiments described herein. The method 700 can be performed by any suitable system or device, such as the processing system 500 of FIG. 5 and/or the processing system 900 of FIG. 9.

At block 702, the processing system 500 receives a first set of three-dimensional (3D) points of an environment. According to one or more embodiments described herein, the first set of 3D points can be a point cloud. According to one or more embodiments described herein, the first set of 3D points are captured by a 3D coordinate measurement device, such as the scanner 520 (e.g., a laser scanner). According to one or more embodiments described herein, the first set of 3D points can be computer-aided design (CAD) data, mesh data, building information modeling (BIM) data, and/or the like, including combinations and/or multiples thereof. CAD data, mesh data, BIM data, and/or the like can be transformed into a point cloud by sampling the surface so that the same registration algorithms can be used as for a laser scan as described herein.

At block 704, the processing system 500 captures a second set of 3D points of the environment using a sensor of a processing device. According to one or more embodiments described herein, the second set of 3D points can be a point cloud. According to one or more embodiments described herein, the first set of 3D points are captured using the sensor(s) 511, which can be a camera (where photogrammetry is used to generate the first set of 3D points), a LIDAR sensor, and/or the like, including combinations and/or multiples thereof.

At block 706, the processing system 500 aligns the first set of 3D points of the environment with the second set of 3D points of the environment to create a point cloud of the environment. According to one or more embodiments described herein, aligning the first set of 3D points of the environment with the second set of 3D points of the environment is performed using 4PCS alignment as described herein. According to one or more embodiments described herein, aligning the first set of 3D points of the environment with the second set of 3D points of the environment is performed using a coarse alignment followed by a fine alignment to refine results of the coarse alignment as described herein. For example, the coarse alignment can be the 4PCS alignment, and the fine alignment can be ICP alignment. According to one or more embodiments described herein, aligning the first set of 3D points of the environment with the second set of 3D points of the environment determines a position and rotation estimate for adjusting the first set of 3D points of the environment to align with the second set of 3D points of the environment. According to one or more embodiments described herein, aligning the first set of 3D points of the environment with the second set of 3D points of the environment uses the position and rotation estimate to move location dependent data for the first set of 3D points of the environment to a correct place relative to the second set of 3D points of the environment. In an example where the first data are CAD data, mesh data, BIM data, and/or the like, that data is automatically registered to second set of 3D points of the environment.

At block 708, the processing system 500 generates, on the display 510, a graphical representation of the point cloud of the environment. According to one or more embodiments described herein, the graphical representation displays at least a portion of the first set of 3D points of the environment as an augmented reality element. An example of the graphical representation of the point cloud is shown, for example, in FIG. 8D. In particular, FIG. 8D depicts an interface 840 displayed on the display 510. The interface 810 shows a graphical representation of the point cloud 841 of the environment 522. In an example where the first data are CAD data, mesh data, BIM data, and/or the like, that data is overlayed with the current view (e.g., the video stream of the environment).

Additional processes also may be included, and it should be understood that the process depicted in FIG. 7 represents an illustration, and that other processes may be added or existing processes may be removed, modified, or rearranged without departing from the scope of the present disclosure.

It is understood that one or more embodiments described herein is capable of being implemented in conjunction with any other type of computing environment now known or later developed. For example, FIG. 9 depicts a block diagram of a processing system 900 for implementing the techniques described herein. In accordance with one or more embodiments described herein, the processing system 900 is an example of a cloud computing node of a cloud computing environment. In examples, processing system 900 has one or more central processing units (“processors” or “processing resources” or “processing devices”) 921a, 921b, 921c, etc. (collectively or generically referred to as processor(s) 921 and/or as processing device(s)). In aspects of the present disclosure, each processor 921 can include a reduced instruction set computer (RISC) microprocessor. Processors 921 are coupled to system memory (e.g., random access memory (RAM) 924) and various other components via a system bus 933. Read only memory (ROM) 922 is coupled to system bus 933 and may include a basic input/output system (BIOS), which controls certain basic functions of processing system 900.

Further depicted are an input/output (I/O) adapter 927 and a network adapter 926 coupled to system bus 933. I/O adapter 927 may be a small computer system interface (SCSI) adapter that communicates with a hard disk 923 and/or a storage device 925 or any other similar component. I/O adapter 927, hard disk 923, and storage device 925 are collectively referred to herein as mass storage 934. Operating system 940 for execution on processing system 900 may be stored in mass storage 934. The network adapter 926 interconnects system bus 933 with an outside network 936 enabling processing system 900 to communicate with other such systems.

A display (e.g., a display monitor) 935 is connected to system bus 933 by display adapter 932, which may include a graphics adapter to improve the performance of graphics intensive applications and a video controller. In one aspect of the present disclosure, adapters 926, 927, and/or 932 may be connected to one or more I/O busses that are connected to system bus 933 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 933 via user interface adapter 928 and display adapter 932. A keyboard 929, mouse 930, and speaker 931 may be interconnected to system bus 933 via user interface adapter 928, which may include, for example, a Super I/O chip integrating multiple device adapters into a single integrated circuit.

In some aspects of the present disclosure, processing system 900 includes a graphics processing unit 937. Graphics processing unit 937 is a specialized electronic circuit designed to manipulate and alter memory to accelerate the creation of images in a frame buffer intended for output to a display. In general, graphics processing unit 937 is very efficient at manipulating computer graphics and image processing, and has a highly parallel structure that makes it more effective than general-purpose CPUs for algorithms where processing of large blocks of data is done in parallel.

Thus, as configured herein, processing system 900 includes processing capability in the form of processors 921, storage capability including system memory (e.g., RAM 924), and mass storage 934, input means such as keyboard 929 and mouse 930, and output capability including speaker 931 and display 935. In some aspects of the present disclosure, a portion of system memory (e.g., RAM 924) and mass storage 934 collectively store the operating system 940 to coordinate the functions of the various components shown in processing system 900.

It will be appreciated that one or more embodiments described herein may be embodied as a system, method, or computer program product and may take the form of a hardware embodiment, a software embodiment (including firmware, resident software, micro-code, etc.), or a combination thereof. Furthermore, one or more embodiments described herein may take the form of a computer program product embodied in one or more computer readable medium(s) having computer readable program code embodied thereon.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A method for point cloud alignment, the method comprising:
receiving a first set of three-dimensional (3D) points of an environment;
capturing a second set of 3D points of the environment using a sensor of a processing system;
aligning the first set of 3D points of the environment with the second set of 3D points of the environment to create a point cloud of the environment; and
generating, on a display of the processing system, a graphical representation of the point cloud of the environment, where the graphical representation displays at least a portion of the first set of 3D points of the environment as an augmented reality element.

2. The method of claim 1, wherein the first set of 3D points were captured by a 3D coordinate measurement device.

3. The method of claim 2, wherein the 3D coordinate measurement device is a laser scanner.

4. The method of claim 1, wherein aligning the first set of 3D points of the environment with the second set of 3D points of the environment is performed using a 4-points congruent sets for robust surface registration (4PCS) alignment.

5. The method of claim 1, wherein aligning the first set of 3D points of the environment with the second set of 3D points of the environment is performed using a coarse alignment followed by a fine alignment to refine results of the coarse alignment.

6. The method of claim 5, wherein the coarse alignment is performed using a 4-points congruent sets for robust surface registration (4PCS) alignment, and wherein the fine alignment is performed using an iterative closest point (ICP) alignment.

7. The method of claim 1, wherein aligning the first set of 3D points of the environment with the second set of 3D points of the environment determines a position and rotation estimate for adjusting the first set of 3D points of the environment to align with the second set of 3D points of the environment.

8. The method of claim 7, wherein aligning the first set of 3D points of the environment with the second set of 3D points of the environment uses the position and rotation estimate to move location dependent data for the first set of 3D points of the environment to a correct place relative to the second set of 3D points of the environment.

9. The method of claim 1, wherein the sensor is a camera and wherein the second set of 3D points are determined using photogrammetry.

10. The method of claim 1, wherein the sensor is a light detection and ranging (LIDAR) sensor.

11. The method of claim 1, wherein the processing system is a smartphone or a tablet computer.

12. The method of claim 1, wherein the 3D coordinate measurement device is a laser scanner that comprises:
a scanner processing system including a scanner controller;
a housing; and
a 3D scanner disposed within the housing and operably coupled to the scanner processing system, the 3D scanner having a light source, a beam steering unit, a first angle measuring device, a second angle measuring device, and a light receiver, the beam steering unit cooperating with the light source and the light receiver to define a scan area, the light source and the light receiver configured to cooperate with the scanner processing system to determine a first distance to a first object point based at least in part on a transmitting of a light by the light source and a receiving of a reflected light by the light receiver, the 3D scanner configured to cooperate with the scanner processing system to determine 3D coordinates of the first object point based at least in part on the first distance, a first angle of rotation, and a second angle of rotation.

13. A system comprising:
a three-dimensional (3D) coordinate measurement device to capture a first set of 3D points of an environment; and
a processing system communicatively coupled to the 3D coordinate measurement device, the processing system comprising:
a display;
a memory comprising computer readable instructions; and
a processing device for executing the computer readable instructions, the computer readable instructions controlling the processing device to perform operations comprising:
receiving the first set of 3D points of the environment from the 3D coordinate measurement device;
capturing a second set of 3D points of the environment using a sensor of the processing system;
aligning the first set of 3D points of the environment with the second set of 3D points of the environment to create a point cloud of the environment; and
generating, on the display, a graphical representation of the point cloud of the environment, where the graphical representation displays at least a portion of the first set of 3D points of the environment as an augmented reality element.

14. The system of claim 13, wherein the first set of 3D points were captured by a 3D coordinate measurement device.

15. The system of claim 14, wherein the 3D coordinate measurement device is a laser scanner.

16. The system of claim 13, wherein aligning the first set of 3D points of the environment with the second set of 3D points of the environment is performed using a 4-points congruent sets for robust surface registration (4PCS) alignment.

17. The system of claim 13, wherein aligning the first set of 3D points of the environment with the second set of 3D points of the environment is performed using a coarse alignment followed by a fine alignment to refine results of the coarse alignment.

18. The system of claim 17, wherein the coarse alignment is performed using a 4-points congruent sets for robust surface registration (4PCS) alignment, and wherein the fine alignment is performed using an iterative closest point (ICP) alignment.

19. The system of claim 13, wherein aligning the first set of 3D points of the environment with the second set of 3D points of the environment determines a position and rotation estimate for adjusting the first set of 3D points of the environment to align with the second set of 3D points of the environment.

20. The system of claim 19, wherein aligning the first set of 3D points of the environment with the second set of 3D points of the environment uses the position and rotation estimate to move location dependent data for the first set of 3D points of the environment to a correct place relative to the second set of 3D points of the environment.

21. The system of claim 13, wherein the sensor is a camera and wherein the second set of 3D points are determined using photogrammetry.

22. The system of claim 13, wherein the sensor is a light detection and ranging (LIDAR) sensor.

23. The system of claim 13, wherein the processing system is a smartphone or a tablet computer.

24. The system of claim 13, wherein the 3D coordinate measurement device is a laser scanner that comprises:
a scanner processing system including a scanner controller;
a housing; and
a 3D scanner disposed within the housing and operably coupled to the scanner processing system, the 3D scanner having a light source, a beam steering unit, a first angle measuring device, a second angle measuring device, and a light receiver, the beam steering unit cooperating with the light source and the light receiver to define a scan area, the light source and the light receiver configured to cooperate with the scanner processing system to determine a first distance to a first object point based at least in part on a transmitting of a light by the light source and a receiving of a reflected light by the light receiver, the 3D scanner configured to cooperate with the scanner processing system to determine 3D coordinates of the first object point based at least in part on the first distance, a first angle of rotation, and a second angle of rotation.
